(19) United States
(12) Patent Application Publication
(10) Pub. No.: US 2026/0145706 A1
(43) Pub. Date: May 28, 2026

(54) VEHICLE CONTROL DEVICE AND METHOD

(71) Applicants: Hyundai Motor Company, Seoul (KR); Kia Corporation, Seoul (KR)

(72) Inventors: Sung Hwan YUN, Hwaseong-Si (KR); Sung Kwan KIM, Hwaseong-Si (KR); Seung Il HAN, Hwaseong-Si (KR)

(21) Appl. No.: 19/227,893

(22) Filed: Jun. 4, 2025

(30) Foreign Application Priority Data
Nov. 27, 2024 (KR) 10-2024-0171912

(51) Int. Cl. B60W 60/00; B60W 40/11

(52) U.S. Cl. CPC B60W 60/0015; B60W 40/11; B60W 2520/105; B60W 2520/16; B60W 2540/18; B60W 2552/35; B60W 2556/40; B60W 2556/50; B60W 2556/65

(57) ABSTRACT

An apparatus of a vehicle may comprise one or more processors, and a memory storing one or more programs that, when executed by the one or more processors communicating with the memory, are configured to cause the apparatus to estimate, based on driving information about the vehicle, a pitch rate, determine, based on the pitch rate, a type of a pothole, transmit pothole notification information indicating the type of the pothole, receive second pothole notification information indicating a type of a second pothole, and control, based on map information updated by the second pothole notification information, a driving operation of the vehicle.

### CROSS-REFERENCE TO RELATED APPLICATION

This application claims the benefit of priority to Korean Patent Application No. 10-2024-0171912, filed in the Korean Intellectual Property Office on Nov. 27, 2024, the entire contents of which are incorporated herein by reference.

### FIELD OF THE DISCLOSURE

Examples relate to a vehicle control device and method.

### BACKGROUND

The matters described in this Background section are only for enhancement of understanding of the background of the disclosure, and should not be taken as acknowledgment that they correspond to prior art already known to those skilled in the art.

Potholes appearing in the road may pose a serious threat to driver safety, and may be an even greater threat for autonomous vehicles because it may be difficult to flexibly respond to potholes.

Autonomous driving technology may respond only to obstacles capable of being recognized, and does not have a reporting system for potholes. The size and depth of potholes on the road may vary greatly, making it difficult to identify and respond to potholes utilizing camera, lidar, or radar recognition technology.

### SUMMARY

The present disclosure is directed to providing a vehicle control device and method capable of classifying types of potholes according to their risk levels, warning drivers of pothole occurrence information, and reflecting the pothole occurrence information in map information.

An apparatus of a vehicle, the apparatus may comprise one or more processors, and a memory storing one or more programs that, when executed by the one or more processors communicating with the memory, are configured to cause the apparatus to estimate, based on driving information about the vehicle, a pitch rate, determine, based on the pitch rate, a type of a pothole, transmit pothole notification information indicating the type of the pothole, receive second pothole notification information indicating a type of a second pothole, and control, based on map information updated by the second pothole notification information, a driving operation of the vehicle.

The apparatus, wherein the one or more programs, when executed by the one or more processors communicating with the memory, are configured to cause the apparatus to classify the type of the pothole based on a risk level associated with the type of the pothole in a driving situation of the vehicle, and output the pothole notification information indicating the type of the pothole, wherein the risk level is set to a first critical level or higher.

The apparatus, wherein the one or more programs, when executed by the one or more processors communicating with the memory, are configured to cause the apparatus to determine, based on global positioning system (GPS) information, a generation location of the pothole, and output the generation location together with the pothole notification information.

The apparatus, wherein the one or more programs, when executed by the one or more processors communicating with the memory, are configured to cause the apparatus to transmit, via a transceiver, the generation location of the pothole and the pothole notification information to a server.

The apparatus, wherein the one or more programs, when executed by the one or more processors communicating with the memory, are configured to cause the apparatus to cause the server to provide, based on aggregated pothole notification information associated with the type of the pothole and received from a plurality of vehicles, map information to the vehicle and an external system, wherein the map information may comprise the generation location of the pothole, and wherein the aggregated pothole notification information, having a risk level set to the first critical level or higher, is accumulated a preset first reference number of times or more.

The apparatus, wherein the one or more programs, when executed by the one or more processors communicating with the memory, are configured to cause the apparatus to cause the server to provide, based on second aggregated pothole notification information associated with the type of the pothole and received from a plurality of vehicles, map information to the vehicle and the external system, wherein the second aggregated pothole notification information, having a risk level set to a second critical level or higher, is accumulated a preset second reference number of times or more.

The apparatus, wherein the second critical level is higher than the first critical level, and wherein the preset second reference number of times is smaller than the preset first reference number of times.

The apparatus, wherein the one or more programs, when executed by the one or more processors communicating with the memory, are configured to cause the apparatus to determine, based on changes in an acceleration of the vehicle and a speed of the vehicle, a rate of change in front inclination of the vehicle and a rate of change in rear inclination of the vehicle, and estimate, based on the determination of the rate of change in front inclination of the vehicle and the rate of change in rear inclination of the vehicle, the pitch rate.

The apparatus, wherein the one or more programs, when executed by the one or more processors communicating with the memory, are configured to cause the apparatus to determine the type of the pothole, based on a speed of the vehicle, an acceleration of the vehicle, the estimated pitch rate, and a steering angle of the vehicle.

The apparatus, wherein the speed, the acceleration, the estimated pitch rate, and the steering angle of the vehicle are used as inputs and the type of the pothole is determined based on a learning model that has learned data labeled with the type of the pothole.

A method performed by an apparatus of a vehicle, the method may comprise estimating, based on driving information about the vehicle, a pitch rate, determining, based on the pitch rate, a type of a pothole, transmitting pothole notification information indicating the type of the pothole, receiving second pothole notification information indicating a type of a second pothole, and controlling, based on map information updated by the second pothole notification information, a driving operation of the vehicle.

The method, wherein the transmitting pothole notification information may comprise classifying the type of the pothole based on a risk level associated with the type of the pothole in a driving situation of the vehicle, and outputting the pothole notification information indicating the type of the pothole, wherein the risk level is set to a first critical level or higher.

The method, wherein the transmitting pothole notification information may comprise determining, based on global positioning system (GPS) information, a generation location of the pothole, and outputting the generation location together with the pothole notification information.

The method may further comprise, after the outputting of the pothole notification information, transmitting, via a transceiver, the generation location of the pothole and the pothole notification information to a server.

The method may further comprise, after the outputting of the pothole notification information, causing the server to provide, based on aggregated pothole notification information associated with the type of the pothole and received from a plurality of vehicles, map information to the vehicle and an external system, wherein the map information may comprise the generation location of the pothole, and wherein the aggregated pothole notification information, having a risk level set to the first critical level or higher, is accumulated a preset first reference number of times or more.

The method may further comprise, after the outputting of the pothole notification information, causing the server to provide, based on second aggregated pothole notification information associated with the type of the pothole and received from a plurality of vehicles, map information to the vehicle and the external system, wherein the second aggregated pothole notification information, having a risk level set to a second critical level or higher, is accumulated a preset second reference number of times or more.

The method, wherein the second critical level is higher than the first critical level, and wherein the preset second reference number of times is smaller than the preset first reference number of times.

The method, wherein the estimating of the pitch rate may comprise determining, based on changes in an acceleration of the vehicle and a speed of the vehicle, a rate of change in front inclination of the vehicle and a rate of change in rear inclination of the vehicle, and estimating, based the determining of the rate of change in front inclination of the vehicle and the rate of change in rear inclination of the vehicle, the pitch rate.

The method, wherein the transmitting pothole notification information may comprise determining the type of the pothole, based on a speed of the vehicle, an acceleration of the vehicle, the estimated pitch rate, and a steering angle of the vehicle.

An apparatus of a vehicle, the apparatus may comprise a processor, and a memory storing at least one instruction that, when executed by the processor communicating with the memory, is configured to cause the apparatus to receive sensor data associated with the vehicle, estimate, based on the sensor data, a pitch rate of the vehicle, detect a road surface anomaly based on the estimated pitch rate, classify the road surface anomaly as one of a plurality of pothole types, transmit a first signal indicating the one of the plurality of pothole types, receive a second signal indicating a pothole type of at least one pothole, and control, based on the second signal, autonomous driving of the vehicle.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example of a vehicle transmitting and receiving data by communicating with another device;

FIG. 2 shows an example of modules constituting a vehicle according to one example of the present disclosure;

FIG. 3 shows an example of an operation of a processor according to the example;

FIG. 4 shows an example of an operation of a first processing unit according to the example;

FIG. 5 shows an example of an operation of a second processing unit according to the example; and

FIG. 6 shows an example of a method of controlling a vehicle according to an example.

### DETAILED DESCRIPTION

Hereinafter, preferred examples of the present disclosure will be described in detail with reference to the accompanying drawings.

However, the technical idea of the present disclosure is not limited to some examples to be described but may be implemented in various different forms, and within the scope of the technical idea of the present disclosure, one or more among components in the examples may be used by being selectively combined and substituted.

Further, unless specifically defined and described, terms used in the examples of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the examples of the present disclosure are for the purpose of describing the examples only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, when describing components of examples of the present disclosure, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component. The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of classifying a type of a pothole) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of classifying a type of a pothole) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of classifying a type of a pothole) described herein.

Minimum risk maneuver (MRM) operation(s) may also be controlled, for example, based on one or more features (e.g., features of classifying a type of a pothole) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of classifying a type of a pothole) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of classifying a type of a pothole) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

Hereinafter, examples will be described in detail with reference to the accompanying drawings, but the same or corresponding components are denoted by the same reference numerals regardless of the drawing numbers, and redundant descriptions thereof will be omitted.

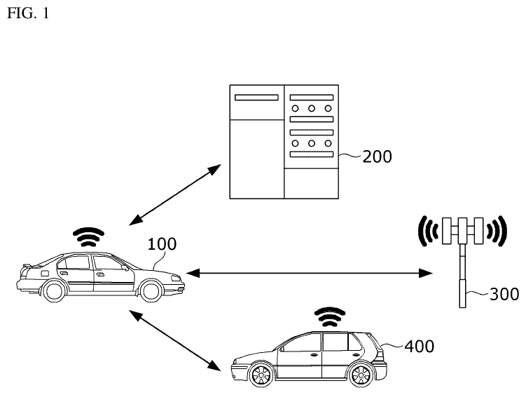

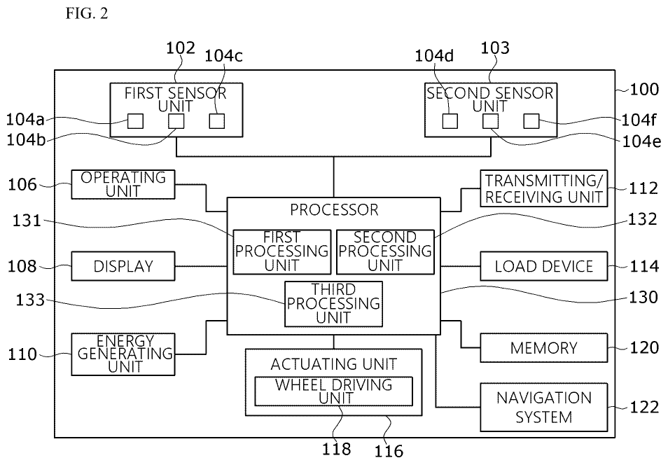

Hereinafter, a vehicle will be described with reference to FIGS. 1 and 2. FIG. 1 shows an example of a vehicle transmitting and receiving data by communicating with another device.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy (e.g., hydrogen, methane, natural gas, or ammonia, etc.), and the vehicle 100 may be filled with gas in a liquefied state, for example. Here, one example of the gas may be hydrogen. However, the gas is not limited thereto, and various gases are applicable. In the case of fossil energy, the vehicle 100 may be driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like (e.g., a fire engine, a garbage truck, a cement mixer, or a mobile crane, etc.). Here, the ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules (e.g., caterpillar tracks, robotic legs, air cushions, or magnetic levitation, etc.). In the present disclosure, ground mobility devices such as ground vehicles are mainly described, but unless it contradicts the present disclosure, the present example may also be applied to air mobility devices such as AAMs, aircraft, or the like, and water mobility devices such as ships, submarines, or the like (e.g., drones, helicopters, ferries, or autonomous underwater vehicles, etc.).

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even if a driving situation is uncertain (e.g., navigating through construction zones, merging into highway traffic, or handling unexpected pedestrian crossings, etc.). Semi-autonomous driving may be provided as autonomous movement that requires driver intervention depending on specific driving situations (e.g., inclement weather, complex intersections, or unmarked roads, etc.). The semi-autonomous driving may be implemented so that the processor 130 transfers control to a user by deactivating autonomous driving if the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5 (e.g., Level 2 involves partial automation like lane-keeping and adaptive cruise control, while Level 4 may allow driverless operation in geo-fenced urban areas, etc.).

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices (e.g., smartphones, smartwatches, tablets, or onboard infotainment controllers, etc.), or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100 (e.g., over-the-air updates, navigation assistance, or traffic-aware route optimization, etc.).

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like (e.g., real-time traffic signals, pedestrian alerts, roadwork notifications, or accident reports, etc.), through vehicle-to-infrastructure (V2I) communication with the vehicle 100. The vehicle 100 may support manual driving or autonomous driving by exchanging the data listed above through vehicle-to-vehicle (V2V) communication with the other vehicle 400 (e.g., sharing blind spot information, emergency braking alerts, or vehicle speed and trajectory data, etc.).

The vehicle 100 may communicate with other vehicles or other devices based on cellular communication, wireless access in vehicular environment (WAVE) communication, dedicated short range communication (DSRC), short-range communication, or other communication methods (e.g., Bluetooth, ultra-wideband (UWB), or satellite communication, etc.).

For example, the vehicle 100 may use a cellular communication network such as LTE or 5G, a WiFi communication network, a WAVE communication network, or the like, for communication with the server 200, the ITS device 300, and the other vehicle 400. For another example, DSRC or the like used in the vehicle 100 may be used for communication between vehicles (e.g., for collision avoidance, lane merge assistance, or coordinated platooning, etc.). The communication method between the vehicle 100, the server 200, the ITS device 300, the other vehicle 400, and the user device is not limited to the above-described example and may vary depending on regional standards, vehicle type, or system requirements.

FIG. 2 shows an example of modules constituting a vehicle according to one example of the present disclosure.

The vehicle 100 may include a sensor unit 102, an operating unit 106, a display 108, a load device 114, and a transmitting/receiving unit 112.

The sensor unit 102 may be provided with various types of detectors to detect various states and situations occurring in an external environment, an internal system, user operation, and a boarding space of the vehicle 100 (e.g., rainfall sensors, cabin occupancy detectors, ambient temperature sensors, or CO₂ monitors, etc.).

Specifically, the first sensor unit 102 may be provided with an externally oriented camera 104a, a lidar sensor 104b, a radar sensor 104c, and the like, to recognize dynamic and static objects present outside the vehicle 100 (e.g., pedestrians, bicycles, road signs, or parked vehicles, etc.). The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate 3D spatial information that identifies at least a shape of the external object (e.g., the height, width, or contour of a nearby vehicle, traffic cone, or curb, etc.). In order to ascertain the presence of an external object and its relative distance, speed, direction, or the like, the radar sensor 104c may emit radio waves of a specific frequency around the vehicle 100 and generate radar data through radio waves reflected from the external object (e.g., moving vehicles, cyclists, or fast-approaching objects, etc.). In the present disclosure, the sensor unit is shown as having the lidar sensor 104b, but in other examples, the lidar sensor 104b may not be mounted, for example, to reduce cost, power consumption, or complexity, depending on the use case.

The first sensor unit 102 may generate object recognition information based on sensing data. The object recognition information may include information on the presence of an object, position information about the object, information on a distance between the vehicle 100 and the object, and information on a relative speed between the vehicle 100 and the object (e.g., detecting a fast-approaching car in an adjacent lane or determining whether a pedestrian is crossing, etc.). In the example, external objects may be various objects related to the operation of the vehicle 100 (e.g., lane markings, traffic lights, guardrails, or roadside construction equipment, etc.).

A second sensor unit 103 may be provided with a positioning sensor 104d, a wheel sensor 104e, an attitude sensor 104f, and the like, to confirm its own location, speed, driving attitude, and the like (e.g., detecting precise vehicle position on a road, current driving direction, wheel rotation rate, or body orientation, etc.). The attitude sensor 104f may include a gyro sensor, an angular velocity sensor, an acceleration sensor, or the like (e.g., a digital compass, tilt sensor, or motion tracker, etc.). The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle (which may reflect turning, tilting, or swaying motions during maneuvers, etc.).

The second sensor unit 103 may generate vehicle driving information based on sensing data. The vehicle driving information may be information generated based on data detected by various sensors installed inside the vehicle (e.g., wheel encoders, throttle position sensors, cabin temperature sensors, or battery health monitors, etc.). For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like (e.g., used for safety checks, energy optimization, or adaptive control algorithms, etc.).

In addition, the vehicle driving information may include route information. The route information may refer to information generated based on a destination input by a vehicle user through the operating unit 106 (e.g., a touchscreen, voice input system, or physical control knob, etc.). The route information may refer to information that indicates a traveling route from a current position of a host vehicle to a destination on a map if the destination has been set. If no destination is set, the route information may refer to information including a road on which the host vehicle is currently traveling and a future driving route including the road (e.g., inferred from habitual driving patterns, real-time traffic predictions, or navigation suggestions, etc.).

The operating unit 106 may be configured as a module that is controlled by the user for driving. For example, the operating unit 106 may be a steering wheel for manual driving, an automatic or manual shift transmission, an accelerator pedal, a brake pedal, or the like (e.g., a gear selector dial, paddle shifter, or electronic parking brake switch, etc.). The operating unit 106 may be further provided with an interface for enabling or disabling an autonomous driving mode and selecting detailed functions requested by the user so that the user may use an autonomous driving function (e.g., selecting lane-keeping assistance, cruise control settings, or auto-parking features, etc.). In order to receive various requests related to autonomous driving, the operating unit 106 may be configured, for example, as a hard-type interface provided at a predetermined position inside the vehicle 100, or as a soft-type interface that can be touched on the display 108. (e.g., buttons on the center console, steering wheel-mounted controls, or virtual buttons on an infotainment screen, etc.) Depending on the specifications of the autonomous vehicle, at least one of the steering wheel, the transmission, and the pedal may be omitted (e.g., in Level 5 autonomous vehicles or concept cars designed for full automation, etc.). For another example, the operating unit 106 may be provided with a module that receives a user's control request for the load device 114 in addition to driving control (e.g., adjusting seat heating, window defrosting, or interior lighting, etc.).

The display 108 may function as a user interface. The display 108 may output and display an operating state, a control state, route/traffic information, remaining energy amount information, content requested by the driver, or the like, of the vehicle 100 by the processor 130 (e.g., navigation maps, rear camera feed, range estimates, or entertainment content, etc.). In addition, the display 108 may be configured as a touch screen capable of detecting a driver's input to receive a driver's request to instruct the processor 130 (e.g., inputting a destination, adjusting climate settings, or selecting audio output, etc.).

The load device 114 is mounted on the vehicle 100 and may be a type of non-driving electrical device excluding a driving power system such as the wheel driving unit 118 or the like. The load device 114 is an auxiliary device that receives electrical power from the energy generating unit 110, and may be, for example, an air conditioning system, a lighting system, a seat system, various devices installed in the vehicle 100, or the like (e.g., USB charging ports, infotainment displays, wireless charging pads, or powered windows, etc.). In the present disclosure, a cooling/heating system that cools or heats at least one of a battery, a fuel cell, an internal combustion engine, an air conditioning system, and a specific part of the vehicle 100 may be further included (e.g., to prevent battery overheating, improve fuel cell efficiency, or maintain engine performance under extreme weather conditions, etc.).

The transmitting/receiving unit 112 may support mutual communication with the server 200, the ITS device 300, surrounding vehicles 300, and the like (e.g., roadside beacons, cloud-based infrastructure, or navigation platforms, etc.). The transmitting/receiving unit 112 may include a module that processes, for example, cellular communication, WAVE, DSRC communication, and the like (e.g., 5G NR, IEEE 802.11p, or Bluetooth Low Energy, etc.). In the present disclosure, the transmitting/receiving unit 112 may transmit data generated or stored while driving to the server 200 and receive data and software modules transmitted from the server 200 (e.g., map updates, firmware patches, or hazard notifications, etc.). The transmitting/receiving unit 112 may support communication with an electronic device carried by an occupant inside the vehicle 100 (e.g., a smartphone, smartwatch, or tablet connected via Bluetooth or Wi-Fi, etc.). In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130 (e.g., red/yellow/green phase timing, countdown signals, or emergency vehicle priority signals, etc.). In addition, the transmitting/receiving unit 112 may receive a control signal from the traffic signal controller and provide the control signal to the processor 130 (e.g., commands to proceed, halt, or reroute based on intersection management protocols, etc.).

In the example, the operating unit 106, the display 108, and the transmitting/receiving unit 112 may constitute audio, video, navigation, telecommunication (AVNT) 150 (e.g., a centralized infotainment and control system integrating real-time media, maps, and connectivity features, etc.).

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, excluding components directly involved in driving operations (e.g., seat position controllers, biometric sensors, or in-cabin air quality monitors, etc.). If the vehicle 100 is driven based on electrical energy, the energy generating unit 110 may be configured as an electric battery charged from the outside, or configured as a combination of an electric battery and a fuel cell that charges the electric battery (e.g., using plug-in charging stations, regenerative braking systems, or hydrogen refill stations, etc.). In the case of the combination of the electric battery and the fuel cell, the energy generating unit 110 may include a tank that stores materials used to produce electric power for the fuel cell, such as liquefied hydrogen. If the vehicle 100 is driven based on fossil energy, the energy generating unit 110 may be configured as an internal combustion engine (e.g., a gasoline, diesel, or LPG-based engine, etc.). In addition, if the vehicle 100 is of a hybrid type, the energy generating unit 110 may be provided as a combination of the internal combustion engine and the electric battery (e.g., enabling switching between electric-only and fuel-based driving modes for fuel efficiency and performance, etc.).

The actuating unit 116 may be provided with at least one module that implements driving operations and perform at least one driving operation among longitudinal control such as acceleration and deceleration and lateral control such as steering, according to a user request from the operating unit 106 (e.g., using a gas pedal for acceleration, brake pedal for deceleration, or steering wheel for turning, etc.). In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118 (e.g., actuators, motors, hydraulic pumps, or electronic control units (ECUs), etc.). If the vehicle 100 is operated based on electrical energy, the actuating unit 116 may include an assembly for transmitting the requested driving operation to the wheel driving unit 118 (e.g., an inverter circuit, motor controller, or torque distribution circuit, etc.). If the vehicle 100 is operated based on fossil energy, the actuating unit 116 may be provided with a transmission and a gear module that transmit the power of the internal combustion engine (e.g., automatic transmission, dual-clutch system, or continuously variable transmission (CVT), etc.).

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels (e.g., electric power steering (EPS), hydraulic brake calipers, or torque vectoring modules, etc.). If the vehicle 100 is driven based on electrical energy, the driving force generating module may be configured as a motor assembly that generates a driving force based on electric power output from the electric battery (e.g., hub motors, axle-mounted motors, or integrated motor drives, etc.). The braking module of the electric-based vehicle 100 may further have a regenerative braking function (e.g., converting kinetic energy back into electrical energy during deceleration to recharge the battery, etc.).

A navigation unit 122 may provide navigation information. The navigation information may include at least one of map information, set destination information, route information according to a set destination, information on various objects on the route, lane information, and current vehicle position information (e.g., traffic congestion alerts, construction zone locations, or lane merge guidance, etc.).

The navigation unit 122 may receive information from an external device through the transmitting/receiving unit 112 and update previously stored information (e.g., downloading real-time traffic data, road closures, or software enhancements, etc.). According to the example, the navigation unit 122 may be classified as a sub-component of the operating unit 106.

In addition, the vehicle 100 may include a memory 120 and the processor 130.

The memory 120 may store applications and various types of data for controlling the vehicle 100, and load applications or read and record data by a request of the processor 130 (e.g., vehicle diagnostics, infotainment content, driver preferences, or machine learning models, etc.).

The processor 130 may perform overall control of the vehicle 100. The processor 130 may be configured to execute applications and instructions stored in the memory 120 (e.g., real-time path planning, sensor data fusion, battery management, or autonomous driving algorithms, etc.).

The processor 130 may include a first processing unit 131, a second processing unit 132, and a third processing unit 133.

The first processing unit 131 may estimate a pitch rate using vehicle driving information (e.g., longitudinal acceleration, velocity, and steering input, etc.).

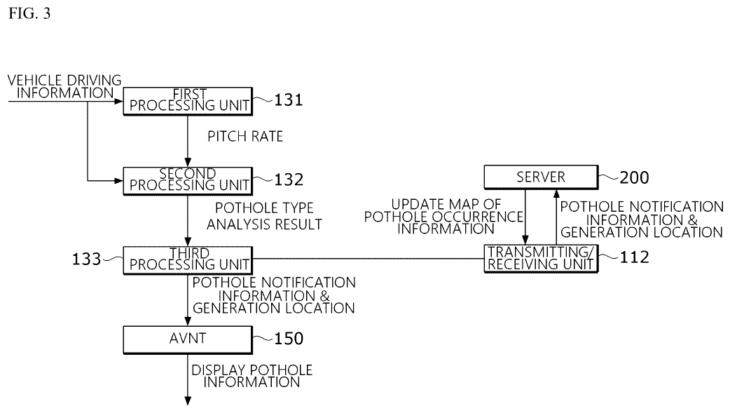

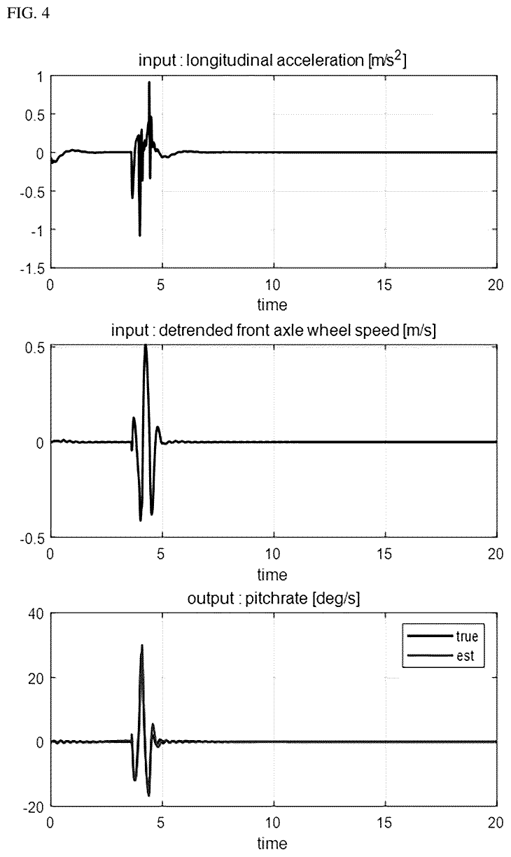

FIG. 3 shows an example of an operation of the processor according to the example. FIG. 4 shows an example of an operation of the first processing unit according to the example. Referring to FIGS. 3 and 4, the first processing unit 131 may calculate a rate of change in the front/rear inclination of the vehicle based on changes in the acceleration and speed of the vehicle and estimate a pitch rate (e.g., if the vehicle accelerates uphill, brakes hard, or crosses a speed bump, etc.).

The first processing unit 131 may utilize dynamic characteristics and a motion equation of the vehicle in a process of calculating the pitch rate using the speed and acceleration of the vehicle. The pitch rate is a speed at which the vehicle rotates forward and backward, and as the unit, rad/s (radian per second) may be used (e.g., for understanding vehicle body movement during sudden deceleration, etc.).

The center of gravity of the vehicle may move forward or backward due to changes (e.g., braking, rapid acceleration, or the like) in the acceleration of the vehicle, and accordingly, the vehicle may make a pitch motion (e.g., nose diving during braking or rear lifting during acceleration, etc.).

The first processing unit 131 may utilize values of a vehicle speed Vx [m/s], an acceleration Ax [m/s²], and a height h [m] of the center of gravity to estimate the pitch rate of the vehicle. The height of the center of gravity is a height of the center of gravity of the vehicle, and plays an important role if the vehicle makes a pitch motion (e.g., a higher center of gravity increases sensitivity to pitch movements, etc.). In addition, the first processing unit 131 may utilize a wheelbase L [m], which is a distance between front and rear wheels of the vehicle. The wheelbase L is a factor that determines a radius of the pitch motion (e.g., a longer wheelbase reduces the severity of pitch angles, etc.). The height h of the center of gravity and the wheelbase L may utilize values stored in the memory in advance as vehicle specifications (e.g., derived from a vehicle configuration file or VIN-based lookup, etc.).

The pitch rate may be calculated primarily using the acceleration Ax and structural characteristics of the vehicle, such as the height h of the center of gravity and the wheelbase L (e.g., for accurately modeling the impact of driving events like pothole traversal or curb drop-offs, etc.).

For example, the first processing unit 131 may calculate the pitch rate according to the following Equation 1.

$$\dot{θ} = \frac{h \cdot Ax}{L} \qquad [ Equation 1 ]$$

If the vehicle accelerates, the center of gravity of the vehicle moves backward, and if the vehicle decelerates (if stepping on the brake), the center of gravity of the vehicle moves forward, and at this time, the vehicle makes a pitch motion (e.g., nose dipping under braking or rear squat under hard acceleration, etc.). Therefore, as the acceleration Ax of the vehicle increases, the pitch rate also increases. That is, the greater the acceleration, the more the vehicle tilts forward and backward (resulting in dynamic load transfer that affects ride stability and passenger comfort, etc.).

A vehicle having a higher center of gravity will have a greater pitch rate. That is, the higher the center of gravity, the greater the pitch motion due to acceleration (e.g., SUVs or vans will generally experience more noticeable pitch than sports cars, etc.).

A vehicle having a long wheelbase has a relatively small pitch rate. For example, if the wheelbase is long, since the distance between the front and rear wheels of the vehicle is far, the forward and backward turning radius becomes longer, which reduces the pitch rate (e.g., luxury sedans or buses experience gentler pitch transitions compared to compact cars, etc.).

That is, the pitch rate of the vehicle may be determined according to a ratio of the acceleration, the height of the center of gravity of the vehicle, and the wheelbase. If the vehicle has high acceleration and a high center of gravity, the pitch rate increases, and if the wheelbase is long, the pitch rate decreases (enabling vehicle control systems to adapt suspension damping or alert the driver accordingly, etc.).

Alternatively, the first processing unit 131 may receive the speed, the acceleration, and inertial measurement unit (IMU) sensor values of the vehicle as inputs utilizing a vehicle dynamic model to calculate the pitch rate (the rate of change in the forward and backward inclination of the vehicle) (e.g., to capture real-time vehicle body dynamics over rough terrain, sudden braking, or aggressive corner entry, etc.). The first processing unit 131 may more precisely predict the longitudinal and pitching behavior of the vehicle by utilizing a half-car model and a model constructed by combining anti-dive and anti-lift mechanisms (which enhance stability under braking and acceleration by counteracting body movement through suspension geometry, etc.).

The half-car model is a two-dimensional dynamic model that simplifies and predicts the longitudinal behavior of the vehicle, and takes into account the suspension behavior of the front and rear wheels (e.g., to simulate acceleration-induced squat or braking-induced dive, etc.). The model is configured to calculate a pitching motion and the motion of the front and rear suspensions that occur as the vehicle moves (e.g., over bumps, dips, or speed humps, etc.).

In the half-car model, the mass distribution includes a sprung mass (mass above the suspension) corresponding to the center of the vehicle body and an unsprung mass (mass under the wheels and suspension) (e.g., tires, brake assemblies, or axles, etc.).

In addition, suspension stiffness and damping include the spring stiffness and damping coefficients of the front and rear suspensions, and the center of gravity CG of the vehicle means that a pitching moment occurs depending on the location of the CG when the vehicle accelerates or decelerates (e.g., under hard braking, more force is transferred to the front suspension depending on CG position, etc.).

The anti-dive mechanism refers to a design that considers a front portion of the vehicle being pushed down when the vehicle suddenly brakes. This is mainly implemented through the suspension link and geometry design, and some of the pitching moment when braking may be offset through the suspension link (e.g., by adjusting the angle of control arms or the placement of suspension pivot points, etc.).

The anti-lift model is a mechanism for reducing a phenomenon in which the front portion of the vehicle is lifted when rapidly accelerating. Likewise, the pitching moment is controlled through the suspension geometry and linking structure (e.g., using multi-link suspension setups or tuned trailing arms, etc.).

Considering these two mechanisms, more sophisticated pitching behavior may be predicted when the vehicle accelerates and decelerates (e.g., enabling smoother ride control and better energy recovery during regenerative braking, etc.).

The first processing unit 131 may utilize the speed, the acceleration, and the IMU sensor data as inputs to the vehicle dynamics model. The current speed of the vehicle is a basic input value for calculating dynamic behavior, and the acceleration is longitudinal acceleration and utilized to calculate the pitching moment according to the acceleration and deceleration of the vehicle (e.g., heavy throttle from a stoplight or braking at a downhill intersection, etc.). The inertial measurement unit (IMU) sensor measures values such as an angular velocity (gyro) and an acceleration (accelerometer) of the vehicle, and in particular, when calculating the pitching behavior, the pitch rate and longitudinal acceleration values measured by the IMU are used as important inputs (e.g., for model calibration or comparison against predicted pitch dynamics, etc.).

The first processing unit 131 may set physical characteristic values of the vehicle, such as the vehicle mass, suspension stiffness, damping coefficient, location of the center of gravity CG, and the like, in the model (e.g., based on manufacturer specifications, sensor calibration, or dynamic adaptation during driving, etc.). The first processing unit 131 may calculate a moment of inertia that occurs at the center of gravity CG of the vehicle when the vehicle accelerates or decelerates, and reflect anti-dive and anti-lift factors to calculate how this moment is distributed and offset (e.g., to reduce front-end dive under emergency braking or rear-end lift under hard launch, etc.).

The first processing unit 131 may compare and correct the angular velocity and acceleration data measured by the IMU with the data predicted by the half-car model, and noise removal and sensor error correction may be performed in this process (e.g., using filtering techniques such as Kalman filtering or signal smoothing algorithms, etc.).

The first processing unit 131 may calculate the pitch angle and pitch rate of the vehicle utilizing the longitudinal acceleration of the vehicle and IMU sensor data (e.g., detecting sudden pitch spikes if traversing potholes, speed bumps, or road dips, etc.). In general, the equation of motion is expressed in the following form.

For example, the first processing unit 131 may estimate the pitch rate according to the following Equation 2.

$$\dot{θ} = \frac{- 2 mh}{{I}_{y} {s}^{2} + {C}_{θ} s + {K}_{θ}} {{a}^{′}}_{x} + \frac{- m ( β b tan {α}_{f} + ( 1 - β ) c tan {α}_{r} )}{{I}_{y} {s}^{2} + {C}_{θ} s + {K}_{θ}} {{a}^{′}}_{x} \qquad [ Equation 2 ]$$

In Equation 2, m is a mass of the vehicle, h is a height of the center of gravity CG of the vehicle, I_{y} is a roll inertia of the vehicle, s is a Laplace transform variable in the complex domain, áₓ is a rate of change in longitudinal acceleration over time, b is a distance between a front axle of the vehicle and the center of gravity CG, c is a distance between a rear axle of the vehicle and the center of gravity CG, and α_{f} and αᵣ are slip angles of front and rear tires, and β is a weight distribution coefficient (the ratio between the front and rear axles) (e.g., indicating how weight shifts under load transfer, which affects suspension compression and body dynamics, etc.).

The first term in Equation 2 describes the pitching motion due to the location of the center of gravity CG of the vehicle. The first term reflects the effect of the moment of inertia that occurs when the vehicle accelerates or decelerates on the pitch rate of the vehicle, and the second term reflects the effect of the suspension geometry considering the anti-dive and anti-lift mechanisms (e.g., how the suspension absorbs or resists pitch movement under specific driving conditions, etc.).

That is, Equation 2 indicates that the pitch rate increases when the vehicle suddenly accelerates or brakes, and the pitching moment of the vehicle changes depending on the slip angle of the front wheels when the vehicle brakes and the slip angle of the rear wheels when the vehicle accelerates (e.g., sharp front slip angles during hard braking lead to forward pitch, while rear slip angles under launch conditions induce rearward pitch, etc.).

The second processing unit 132 may output the results of analyzing the type of pothole using the driving information and the estimated pitch rate (e.g., to distinguish between shallow surface cracks and deep potholes based on vehicle dynamics, etc.).

The pitch rate refers to a rate of change in the front-rear direction (front-rear inclination) of the vehicle, and since it significantly changes if the vehicle passes over a road irregularity such as a pothole, road conditions may be identified using the pitch rate (e.g., detecting vertical jolts or sudden body dips, etc.). The pitch rate of the vehicle may have a characteristic of rapidly increasing when the front wheels contact the pothole, and rapidly decreasing when the front wheels pass over the pothole and contact the rear (e.g., creating a spike-then-drop pattern in the pitch signal trace, etc.).

This pattern of the rapid change in pitch rate may provide important information on the size and impact strength of the pothole (e.g., whether the irregularity is likely to affect ride comfort, tire wear, or suspension damage, etc.).

In the example, the second processing unit 132 may classify the type of pothole according to a risk level in a driving situation of the vehicle (e.g., classifying potholes as safe, cautionary, or dangerous based on severity thresholds, etc.). The second processing unit 132 may analyze the type of pothole using the speed, the acceleration, the estimated pitch rate, and the steering angle of the vehicle (e.g., considering turning radius, entry speed, and vertical jolt profile for accurate classification, etc.).

For example, the second processing unit 132 may analyze the type of pothole by analyzing the pitch rate pattern based on the speed, acceleration, and steering angle of the vehicle (e.g., detecting a sharp pitch spike at moderate speed with low steering input as indicative of a medium-depth pothole, etc.). The second processing unit 132 may compare a pattern of a reference pitch rate stored in the memory with the pattern of the pitch rate estimated by the first processing unit 131 and determine a similarity (e.g., by overlaying the pitch signal waveform with pre-recorded pothole response profiles, etc.). The pattern of the reference pitch rate stored in the memory is experimental data obtained by determining the risk level of a pothole through a preliminary experiment, and may refer to data in which the speed, acceleration, steering angle, pitch rate, and risk level values of the vehicle are included (e.g., labeled datasets gathered from instrumented test vehicles on controlled road surfaces, etc.).

The second processing unit 132 may detect a reference pitch rate pattern that matches the speed, acceleration, steering angle, and pitch rate of the traveling vehicle (e.g., to determine if a sudden jolt correlates with a known severe pothole profile, etc.). In this case, the second processing unit 132 may determine the similarity of the pitch rate using the cosine similarity technique (e.g., to evaluate angular similarity between two multidimensional vectors representing time-series pitch signals, etc.).

The second processing unit 132 may detect the pattern of the reference pitch rate having the highest similarity from the memory and analyze the type of pothole through the risk level of the detected pitch rate (e.g., classifying it as Safe, Caution, or Danger based on predefined match thresholds, etc.).

Alternatively, the second processing unit 132 may use the speed, the acceleration, the estimated pitch rate, and the steering angle of the vehicle as inputs and determine the type of the pothole through a learning model that has learned data labeled with the type of pothole (e.g., a neural network trained with real-world data tagged as “minor bump,” “moderate dip,” or “hazardous pothole,” etc.).

The second processing unit 132 may learn dynamic data collected while the vehicle is traveling utilizing a long short-term memory (LSTM) network, and through the learning, label the states of potholes on the road into Safe, Caution, and Danger levels to determine the type of pothole (e.g., enabling automatic classification of road anomalies during autonomous driving, etc.).

If the risk level is Safe, it may mean minor irregularities or a flat road (e.g., shallow cracks or slight surface undulations, etc.), if the risk level is Caution, it may mean a medium-sized pothole that requires the driver to slow down (e.g., enough to cause discomfort or steering instability, etc.), and if the risk level is Danger, it may mean a large pothole that may cause a serious impact to the vehicle (e.g., risk of tire blowout, suspension damage, or loss of control, etc.).

The learning model may use the speed, the longitudinal acceleration, the steering angle, and the estimated pitch rate of the vehicle as inputs to the network (e.g., to detect subtle patterns in vehicle behavior triggered by road hazards, etc.). The learning model may classify road conditions and the risk levels of potholes based on the input data (e.g., mapping sensor-derived input patterns to a severity score using supervised classification, etc.).

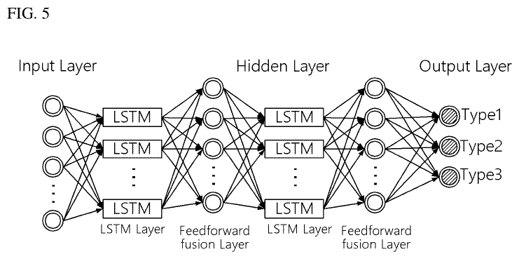

FIG. 5 shows an example of an operation of the second processing unit according to the example. Referring to FIG. 5, the LSTM is a type of recurrent neural network (RNN) and is a model that has strengths in processing time series data or continuous data (e.g., tracking fluctuations in driving dynamics across milliseconds or seconds, etc.). Since vehicle dynamics data continuously changes over time, using an LSTM model, a temporal pattern may be more accurately learned (e.g., learning the “signature” motion pattern caused by hitting a pothole at different speeds, etc.).

The learning model may learn an occurrence pattern of a pothole by remembering important information from the past and forgetting unnecessary information through internal mechanisms such as a forget gate, an input gate, and an output gate (e.g., filtering out steady driving and focusing on abrupt pitch changes, etc.).

Training data is time series data including the speed, the longitudinal acceleration, the steering angle, and the pitch rate of the vehicle, and may be labeled as safe, caution, and dangerous levels depending on the state of the pothole (e.g., based on field test data collected under controlled and real-road driving scenarios, etc.).

The second processing unit 132 may normalize the collected vehicle dynamics data (the pitch rate, the speed, the acceleration, and the steering angle) and convert the normalized data into a time series format (e.g., scaling inputs between 0 and 1 and segmenting them into uniform time windows, etc.). The second processing unit 132 may use the time series data as an input to allow the LSTM network to learn the temporal pattern (e.g., detecting sequential changes that distinguish potholes from speed bumps or dips, etc.). In this case, cross-entropy may be used as a loss function to minimize a prediction error of the model (e.g., penalizing incorrect classification of high-risk potholes as low-risk, etc.). As an optimization algorithm, Adam Optimizer or the like may be used (e.g., for faster convergence and stable training performance, etc.).

The second processing unit 132 may input the speed, the longitudinal acceleration, and the steering angle data collected from the vehicle in real time and the pitch rate estimated by the first processing unit 131 into the LSTM network for the trained model (e.g., streaming normalized sensor values to the model at 10-50 Hz for real-time analysis, etc.).

The second processing unit 132 analyzes a temporal relationship of time series data and compares the analyzed relationship with the learned pattern of the change in road conditions while traveling (e.g., identifying whether the sequence of motion resembles previously learned impact events, etc.). The LSTM model may classify the road condition into one of three levels: Safe, Caution, or Danger based on the input data. For example, the type of pothole may be classified as Danger if the pitch rate rapidly changes and a spike occurs in acceleration data (e.g., suggesting a deep or abrupt road depression likely to affect vehicle safety or comfort, etc.).

The third processing unit 133 may generate pothole notification information on the type of pothole and output notification information on the pothole type whose risk level is set to a first critical level or higher through AVNT (e.g., if the pothole is classified as a moderate or severe threat to driving conditions, etc.). In the example, the pothole notification information may include the type (risk level) of the pothole (e.g., labeling it as Safe, Caution, or Danger on a dashboard interface, etc.).

The third processing unit 133 may determine a generation location of the pothole using GPS information and output the generation location together with notification information (e.g., displaying a pinpoint marker on a real-time navigation map within the vehicle, etc.). The GPS information may be collected through the navigation system of FIG. 2, and the generation location of the pothole may be determined from the coordinates of the GPS information (e.g., by capturing latitude and longitude at the moment of peak pitch change, etc.).

In the example, the first critical level may refer to the pothole type having a risk level of Caution. Accordingly, the third processing unit 133 may output the pothole notification information through the AVNT if the pothole type analyzed by the second processing unit 132 is Caution or Danger. The AVNT may visually and/or audibly output the notification information (e.g., a pop-up alert on the display screen and/or a voice prompt warning the driver, etc.). For example, the AVNT may output a warning signal indicating that the pothole has been formed. Alternatively, the AVNT may visually or textually indicate the location where the pothole has been generated on a navigation map (e.g., highlighting the location in red with a “Caution” or “Danger” label, etc.).

The third processing unit 133 may transmit the generation location of the pothole and the notification information to the server 200 through the transmitting/receiving unit (e.g., enabling cloud-based aggregation of pothole data for fleet-wide analysis or map updates, etc.). The third processing unit 133 may transmit the generation location of the pothole to the server 200 together with the notification information on the pothole type set to the first critical level or higher (e.g., to share crowd-sourced road condition data with infrastructure management systems, etc.).

The server 200 may perform data communication with a plurality of vehicles. The server 200 may perform data communication with a plurality of vehicles through wireless communication (e.g., cellular networks, DSRC, or V2X protocols, etc.).

The server 200 may receive pothole notification information and position information from the plurality of vehicles. The server 200 may collect pothole notification information and position information from the plurality of vehicles and statistically process the pothole notification information and position information (e.g., by clustering reports from different vehicles to confirm pothole reliability, calculating average severity scores, or identifying high-frequency impact zones, etc.). In addition, the server 200 may provide pothole-related information to an external system (e.g., municipal road maintenance platforms, third-party traffic apps, or infrastructure planning systems, etc.). In addition, the server 200 may update the pothole occurrence information on map information. The pothole occurrence information may be updated through a process of visually or audibly indicating that the pothole is generated at the location where the pothole is generated (e.g., placing a hazard icon on the map or triggering an audio warning for upcoming road damage, etc.).

In the example, the external system may include a public institution that manages road information, traffic information, navigation information, and the like (e.g., a city transportation department, state highway authority, or third-party map provider, etc.).

The server 200 may provide the pothole notification information and map information in which the generation location of the pothole and the pothole notification information are reflected to the vehicle and an external system if the notification information on the pothole type whose risk level is set to the first critical level or higher is accumulated a preset first reference number of times or more (e.g., updating maps only after three or more vehicles report the same Caution-level pothole, etc.).

In addition, the server 200 may provide the pothole notification information and map information in which the generation location of the pothole and the pothole notification information are reflected to the vehicle and external system if the notification information on the pothole type whose risk level is set to a second critical level or higher is accumulated a preset second reference number of times or more (e.g., updating maps after only one or two reports for potholes classified as Danger, etc.).

In the example, the risk level of the second critical level may be higher than the risk level of the first critical level, and the second reference number of times may be less than the first reference number of times. For example, the risk level of the first critical level may be Caution, and the risk level of the second critical level may be Danger (e.g., Danger-level potholes receive faster reporting priority to alert other vehicles in near real-time, etc.).

The server 200 may receive pothole notification information from a plurality of vehicles, and when pothole notification information is cumulatively received for the same location, the server 200 may update pothole occurrence information on the map (e.g., flagging the road segment as damaged or degraded, prompting future maintenance alerts, etc.). The server 200 may transmit the updated map to the vehicle and external system (e.g., enabling route re-planning or driver warnings based on real-time road conditions, etc.).

In this case, if the type of pothole is Danger, the server 200 may prevent an accident due to the pothole in advance by updating the pothole occurrence information to the map information even if a relatively small number of times are cumulatively received (e.g., immediately after one or two vehicles report severe impact data, etc.).

If the type of pothole is Caution, the server 200 may update the pothole occurrence information to the map information when a relatively large number of times are cumulatively received compared to when the type of pothole is Danger, thereby preventing accidents due to potholes in advance (e.g., requiring at least five or more consistent reports before map update, etc.).

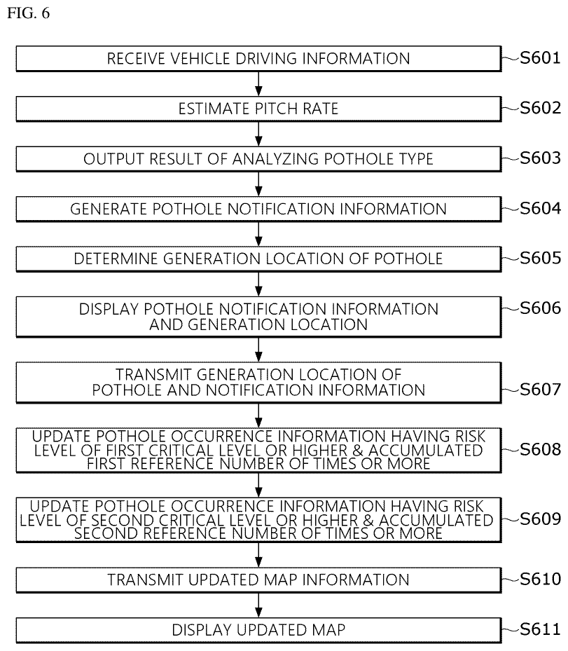

FIG. 6 shows an example of a method of controlling a vehicle according to an example. Referring to FIG. 6, first, the processor 300 receives vehicle driving information from the sensor unit. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like (e.g., collected from IMUs, wheel sensors, OBD modules, and in-cabin environmental sensors, etc.) (S601).

Next, the processor 300 estimates a pitch rate using the vehicle driving information. The processor 300 may receive speed, acceleration, and IMU sensor values as inputs utilizing the vehicle dynamic model and calculate a pitch rate (e.g., applying a half-car model with anti-dive/anti-lift compensation to obtain a forward/rearward body tilt velocity, etc.) (S602).

Next, the processor 300 may output a result of analyzing the type of pothole using the driving information and the estimated pitch rate. The processor 300 may compare a pattern of a reference pitch rate stored in the memory with a pattern of the pitch rate estimated by the first processing unit, determine the similarity, and analyze the type of pothole using a pattern of the most similar pitch rate (e.g., selecting from pre-labeled “Safe,” “Caution,” or “Danger” templates based on cosine similarity, etc.). Alternatively or additionally, the processor 300 may use the speed, the acceleration, the estimated pitch rate, and the steering angle of the vehicle as inputs and determine the type of pothole through a learning model that has learned data labeled with the type of pothole (e.g., via LSTM trained on real-world time-series driving data, etc.) (S603).

Next, the processor 300 may generate pothole notification information on the type of pothole (e.g., tagging it as Safe, Caution, or Danger with a timestamp and pitch profile, etc.) (S604).

Next, the processor 300 may determine a generation location of a pothole through the navigation system (e.g., using GPS coordinates from the navigation module to associate the pothole with a specific road segment or intersection, etc.) (S605).

Next, the processor 300 may output notification information on the type of pothole whose risk level is set to the first critical level or higher through AVNT (e.g., displaying a visual alert or playing an audible warning about an upcoming hazard, etc.) (S606).

Next, the processor 300 may transmit the generation location of the pothole and the notification information to the server 200 through the transmitting/receiving unit (e.g., via 4G/5G, V2X, or Wi-Fi connectivity modules, etc.) (S607).

Next, the server 200 may provide the pothole notification information and map information in which the generation location of the pothole and the pothole notification information are reflected to the vehicle and an external system if the notification information on the pothole type whose risk level is set to a first critical level or higher is accumulated a preset first reference number of times or more (e.g., updating the map after receiving at least five Caution-level reports for the same location, etc.) (S608 and S610).

In addition, the server 200 may provide the pothole notification information and map information in which the generation location of the pothole and the pothole notification information are reflected to the vehicle and external system if the notification information on the pothole type whose risk level is set to a second critical level or higher is accumulated a preset second reference number of times or more (e.g., pushing map updates after just one or two Danger-level reports, etc.) (S609 and S610).

Next, the vehicle may update a map in which the pothole occurrence information received from the server 200 is updated in the navigation system and display the map on the AVNT (e.g., overlaying a pothole warning icon or shaded region on the live route display, etc.) (S611).

According to an example of the present disclosure, there is provided a vehicle control device including one or more processors and a memory configured to store one or more programs executed by the one or more processors, in which the processor is configured to estimate a pitch rate using driving information about a vehicle, output a result obtained by analyzing a type of pothole using the driving information and the estimated pitch rate, and generate and output pothole notification information on the type of pothole.

The processor may classify the type of pothole according to a risk level in a driving situation of the vehicle and output notification information on the pothole type whose risk level is set to a first critical level or higher.

The processor may determine a generation location of the pothole using global positioning system (GPS) information and output the generation location together with the notification information.

The processor may transmit the generation location of the pothole and the notification information to a server through a transmitting/receiving unit.

The server may provide the pothole notification information and map information in which the generation location of the pothole and the pothole notification information are reflected to the vehicle and an external system if the notification information on the pothole type whose risk level is set to the first critical level or higher is accumulated a preset first reference number of times or more.

The server may provide the pothole notification information and map information in which the generation location of the pothole and the pothole notification information are reflected to the vehicle and external system if the notification information on the pothole type whose risk level is set to a second critical level or higher is accumulated a preset second reference number of times or more.

The risk level of the second critical level may be higher than the risk level of the first critical level, and the second reference number of times may be smaller than the first reference number of times.

The processor may calculate a rate of change in front/rear inclination of the vehicle based on changes in an acceleration and a speed of the vehicle and estimates the pitch rate.

The processor may analyze the type of pothole using a speed, an acceleration, the estimated pitch rate, and a steering angle of the vehicle.

The processor may use the speed, the acceleration, the estimated pitch rate, and the steering angle of the vehicle as inputs and determine the type of pothole through a learning model that has learned data labeled with the type of pothole.

According to another example of the present disclosure, there is provided a method performed by a computing device including one or more processors and a memory configured to store one or more programs executed by the one or more processors, including estimating, by the processor, a pitch rate using driving information about a vehicle, outputting, by the processor, a result obtained by analyzing a type of pothole using the driving information and the estimated pitch rate, and generating and outputting, by the processor, pothole notification information on the type of pothole.

The outputting of the result obtained by analyzing the type of pothole may include classifying the type of pothole according to a risk level in a driving situation of the vehicle and outputting notification information on the pothole type whose risk level is set to a first critical level or higher.

The outputting of the notification information may include determining a generation location of the pothole using GPS information and outputting the generation location together with the notification information.

The method may further include, after the outputting of the notification information, transmitting the generation location of the pothole and the notification information to a server through a transmitting/receiving unit.

The method may further include, after the outputting of the notification information, providing the pothole notification information and map information in which the generation location of the pothole and the pothole notification information are reflected to the vehicle and an external system if the notification information on the pothole type whose risk level is set to the first critical level or higher is accumulated a preset first reference number of times or more.

The method may further include, after the outputting of the notification information, providing the pothole notification information and map information in which the generation location of the pothole and the pothole notification information are reflected to the vehicle and external system if the notification information on the pothole type whose risk level is set to a second critical level or higher is accumulated a preset second reference number of times or more.

The risk level of the second critical level may be higher than the risk level of the first critical level, and the second reference number of times may be smaller than the first reference number of times.

The estimating of the pitch rate may include calculating a rate of change in front/rear inclination of the vehicle based on changes in an acceleration and a speed of the vehicle and estimating the pitch rate.

The outputting of the result obtained by analyzing the type of pothole may include analyzing the type of pothole using a speed, an acceleration, the estimated pitch rate, and a steering angle of the vehicle.

The outputting of the result obtained by analyzing the type of pothole may include using the speed, the acceleration, the estimated pitch rate, and the steering angle of the vehicle as inputs and determining the type of pothole through a learning model that has learned data labeled with the type of pothole.

The term “˜unit” used in the present example refers to software components or hardware components such as a field-programmable gate array (FPGA) or an application specific integrated circuit (ASIC), and “˜unit” performs certain functions. However, the “˜unit” is not limited to software or hardware. The “˜unit” may be configured to reside in an addressable storage medium, or may be configured to reproduce one or more processors. Therefore, for example, “˜unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “˜unit” may be combined into smaller numbers of components and “˜units,” or may be further divided into additional components and “˜units.” Furthermore, the components and “˜units” may be implemented to reproduce one or more CPUs in a device or a security multimedia card.

A vehicle control device and method according to an example can classify types of potholes according to their risk levels.

In addition, when a pothole that may affect vehicle driving is detected, the pothole can be visually and audibly displayed to a vehicle driver.

In addition, pothole occurrence information can be reflected in map information in real time.

In addition, pothole-related information can be collected from a plurality of vehicles and statistically processed, and various measures can be taken based on the statistical results.

In this way, the vehicle control device and method can be used for autonomous driving or can induce safe driving.

Although the preferred examples of the present disclosure have been described above, it is understood that those skilled in the art can make various changes and modifications to the present disclosure without departing from the spirit and scope of the present disclosure set forth in the claims below.

What is claimed:

1. An apparatus of a vehicle, the apparatus comprising:
one or more processors; and
a memory storing one or more programs that, when executed by the one or more processors communicating with the memory, are configured to cause the apparatus to:
estimate, based on driving information about the vehicle, a pitch rate,
determine, based on the pitch rate, a type of a pothole,
transmit pothole notification information indicating the type of the pothole,
receive second pothole notification information indicating a type of a second pothole, and
control, based on map information updated by the second pothole notification information, a driving operation of the vehicle.

2. The apparatus of claim 1, wherein the one or more programs, when executed by the one or more processors communicating with the memory, are configured to cause the apparatus to:
classify the type of the pothole based on a risk level associated with the type of the pothole in a driving situation of the vehicle, and
output the pothole notification information indicating the type of the pothole, wherein the risk level is set to a first critical level or higher.

3. The apparatus of claim 2, wherein the one or more programs, when executed by the one or more processors communicating with the memory, are configured to cause the apparatus to:
determine, based on global positioning system (GPS) information, a generation location of the pothole, and
output the generation location together with the pothole notification information.

4. The apparatus of claim 3, wherein the one or more programs, when executed by the one or more processors communicating with the memory, are configured to cause the apparatus to transmit, via a transceiver, the generation location of the pothole and the pothole notification information to a server.

5. The apparatus of claim 4, wherein the one or more programs, when executed by the one or more processors communicating with the memory, are configured to cause the apparatus to cause the server to provide, based on aggregated pothole notification information associated with the type of the pothole and received from a plurality of vehicles, map information to the vehicle and an external system, wherein the map information comprises the generation location of the pothole, and wherein the aggregated pothole notification information, having a risk level set to the first critical level or higher, is accumulated a preset first reference number of times or more.

6. The apparatus of claim 5, wherein the one or more programs, when executed by the one or more processors communicating with the memory, are configured to cause the apparatus to cause the server to provide, based on second aggregated pothole notification information associated with the type of the pothole and received from a plurality of vehicles, map information to the vehicle and the external system, wherein the second aggregated pothole notification information, having a risk level set to a second critical level or higher, is accumulated a preset second reference number of times or more.

7. The apparatus of claim 6, wherein the second critical level is higher than the first critical level, and wherein the preset second reference number of times is smaller than the preset first reference number of times.

8. The apparatus of claim 1, wherein the one or more programs, when executed by the one or more processors communicating with the memory, are configured to cause the apparatus to:
determine, based on changes in an acceleration of the vehicle and a speed of the vehicle, a rate of change in front inclination of the vehicle and a rate of change in rear inclination of the vehicle, and
estimate, based on the determination of the rate of change in front inclination of the vehicle and the rate of change in rear inclination of the vehicle, the pitch rate.

9. The apparatus of claim 1, wherein the one or more programs, when executed by the one or more processors communicating with the memory, are configured to cause the apparatus to determine the type of the pothole, based on a speed of the vehicle, an acceleration of the vehicle, the estimated pitch rate, and a steering angle of the vehicle.

10. The apparatus of claim 9, wherein the speed, the acceleration, the estimated pitch rate, and the steering angle of the vehicle are used as inputs and the type of the pothole is determined based on a learning model that has learned data labeled with the type of the pothole.

11. A method performed by an apparatus of a vehicle, the method comprising:
estimating, based on driving information about the vehicle, a pitch rate;
determining, based on the pitch rate, a type of a pothole;
transmitting pothole notification information indicating the type of the pothole;
receiving second pothole notification information indicating a type of a second pothole; and
controlling, based on map information updated by the second pothole notification information, a driving operation of the vehicle.

12. The method of claim 11, wherein the transmitting pothole notification information comprises:
classifying the type of the pothole based on a risk level associated with the type of the pothole in a driving situation of the vehicle; and
outputting the pothole notification information indicating the type of the pothole, wherein the risk level is set to a first critical level or higher.

13. The method of claim 12, wherein the transmitting pothole notification information comprises:
determining, based on global positioning system (GPS) information, a generation location of the pothole; and
outputting the generation location together with the pothole notification information.

14. The method of claim 13, further comprising, after the outputting of the pothole notification information, transmitting, via a transceiver, the generation location of the pothole and the pothole notification information to a server.

15. The method of claim 14, further comprising, after the outputting of the pothole notification information, causing the server to provide, based on aggregated pothole notification information associated with the type of the pothole and received from a plurality of vehicles, map information to the vehicle and an external system, wherein the map information comprises the generation location of the pothole, and wherein the aggregated pothole notification information, having a risk level set to the first critical level or higher, is accumulated a preset first reference number of times or more.

16. The method of claim 15, further comprising, after the outputting of the pothole notification information, causing the server to provide, based on second aggregated pothole notification information associated with the type of the pothole and received from a plurality of vehicles, map information to the vehicle and the external system, wherein the second aggregated pothole notification information, having a risk level set to a second critical level or higher, is accumulated a preset second reference number of times or more.

17. The method of claim 16, wherein the second critical level is higher than the first critical level, and wherein the preset second reference number of times is smaller than the preset first reference number of times.

18. The method of claim 11, wherein the estimating of the pitch rate comprises:
determining, based on changes in an acceleration of the vehicle and a speed of the vehicle, a rate of change in front inclination of the vehicle and a rate of change in rear inclination of the vehicle; and
estimating, based the determining of the rate of change in front inclination of the vehicle and the rate of change in rear inclination of the vehicle, the pitch rate.

19. The method of claim 11, wherein the transmitting pothole notification information comprises determining the type of the pothole, based on a speed of the vehicle, an acceleration of the vehicle, the estimated pitch rate, and a steering angle of the vehicle.

20. An apparatus of a vehicle, the apparatus comprising:
a processor; and
a memory storing at least one instruction that, when executed by the processor communicating with the memory, is configured to cause the apparatus to:
receive sensor data associated with the vehicle;
estimate, based on the sensor data, a pitch rate of the vehicle;
detect a road surface anomaly based on the estimated pitch rate;
classify the road surface anomaly as one of a plurality of pothole types;
transmit a first signal indicating the one of the plurality of pothole types;
receive a second signal indicating a pothole type of at least one pothole; and
control, based on the second signal, autonomous driving of the vehicle.
